(19) United States
(12) Patent Application Publication
(10) Pub. No.: US 2004/0088260 A1
(43) Pub. Date: May 6, 2004

(54) Secure user authentication

(76) Inventors: Ward Scott Foster, Boise, ID (US); Charles J. Gazdik, Boise, ID (US); Shell Sterling Simpson, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/286,063

(22) Filed: Oct. 31, 2002

(51) Int. Cl. G06F 17/60

(52) U.S. Cl. 705/64

(57) ABSTRACT

A method for authenticating a user before granting access to a network resource. In response to a first request from a client to access the resource, access data for an authentication service and return access data for the resource are acquired. The client is then directed to request authentication, the direction including the access data for the authentication service and the return access data for the resource. The client requests access the authentication service using the access data an the return access data. If the authentication service successfully verifies the source of the request, it then directs the client to again request access to the resource using the return access data.

### FIELD OF THE INVENTION

The present invention is directed to accessing a network resource. More particularly, the invention is directed to securely authenticating a user attempting to access a network resource.

### BACKGROUND

In a basic desktop computing environment, a computer, accessing data from its hard drive, performs a specified function such as word processing, displaying information on a screen, and, when requested, producing a document on a connected printer. In a distributed computing environment, the resources found in the desktop environment are spread across any number of interconnected devices. For example, a client accesses a resource over the Internet. Accessing data provided by the client or located and retrieved from another device, the resource performs specified tasks. These tasks include, among a multitude of others, manipulating the data as instructed, returning the data for use by the client, and/or sending data to a printer for production.

The following provides a more specific example of a distributed computing system utilized to print documents. A client computer, utilizing a web browser and the Internet, accesses a web server providing a document printing resource. The web server may be running on a device connected to or networked with one or more printers. Alternatively, the web server may be embedded in the printer itself. The printing resource locates available printers and a data resource managing electronic documents. The printing service then returns to the browser a graphical interface containing user accessible controls for selecting a document from the data resource as well as controls for selecting a printer. Selections made through the interface are returned to the printing resource. Accessing the data resource, the printing resource retrieves and/or sends the selected document to the selected printer for production.

Accessing distributed resources raises a number of security considerations. Access to a resource may be limited for commercial or privacy purposes. Using the example above, a user may be a paid subscriber enabling access to the printing resource. The user may pay a flat rate or may pay for each use. For commercial security, the user may be required to present credentials such as a user name and password in order to access the printing resource. The same may be true for the data resource. However, presenting credentials to the data resource also promotes user privacy. A user may store documents on the data resource that the user desires to keep private and secure.

Consequently, it is often important and sometimes crucial to authenticate the identity of a user before granting that user access to the network resource. Conventional approaches include providing the network resource with programming capable of authenticating a user by, for example, verifying the validity of credentials presented by the user. While this authentication programming may not be located on the same computing device as the particular resource, it is centralized effectively operating and located on the same site. This centralized approach to authentication leads to network communication “bottlenecks” and decreased performance. Additionally, the centralized approach creates security risks providing a single point of attack for an unscrupulous third party.

### SUMMARY

Accordingly, the present invention relates to authenticating a user before granting access to a network resource. In response to a first request from a client to access the resource, access data for an authentication service and return access data for the resource are acquired. The client is then directed to request authentication, the direction including the access data for the authentication service and the return access data for the resource. The client requests access the authentication service using the access data and the return access data. If the authentication service successfully verifies the source of the request, it then directs the client to again request access to the resource using the return access data.

### DESCRIPTION OF THE DRAWINGS

FIG. 1 is a schematic representation of a computer network in which various embodiments of the present invention may be incorporated.

FIG. 2 is a block diagram of the network of FIG. 1 illustrating the logical program components operating on each device according to an embodiment of the present invention.

FIG. 3 is a block diagram illustrating a security module according to an embodiment of the present invention.

FIG. 4 is a table illustrating an authentication database according to an embodiment of the present invention.

FIG. 5 is a flow diagram illustrating the steps taken to access a resource according to an embodiment of the present invention.

### DETAILED DESCRIPTION

Glossary:

Program: An organized list of electronic instructions that, when executed, causes a device to behave in a predetermined manner. A program can take many forms. For example, it may be software stored on a computer's disk drive. It may be firmware written onto read-only memory. It may be embodied in hardware as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components.

Client—Server: A model of interaction between two programs. For example, a program operating on one network device sends a request to a program operating on another network device and waits for a response. The requesting program is referred to as the “client” while the device on which the client operates is referred to as the “client device.” The responding program is referred to as the “server,” while the device on which the server operates is referred to as the “server device.” The server is responsible for acting on the client request and returning the requested information, if any, back to the client. This requested information may be an electronic file such as a word processing document or spread sheet, a web page, or any other electronic data to be displayed or used by the client. In any given network there may be multiple clients and multiple servers. A single device may contain programming allowing it to operate both as a client device and as a server device. Moreover, a client and a server may both operate on the same device.

Web Server: A server that implements HTTP (Hypertext Transport Protocol). A web server can host a web site or a web service. A web site provides a user interface by supplying web pages to a requesting client, in this case a web browser. Web pages can be delivered in a number of formats including, but not limited to, HTML (Hyper-Text Markup Language) and XML (eXtensible Markup Language). Web pages may be generated on demand using server side scripting technologies including, but not limited to, ASP (Active Server Pages) and JSP (Java Server Pages). A web page is typically accessed through a network address. The network address can take the form of an URL (Uniform Resource Locator), IP (Internet Protocol) address, or any other unique addressing mechanism. A web service provides a programmatic interface which may be exposed using a variety of protocols layered on top of HTTP, such as SOAP (Simple Object Access Protocol).

Interface: The junction between a user and a computer program providing commands or menus through which a user communicates with the program. The term user in this context represents generally any individual or mechanism desiring to communicate with the program. For example, in the client-server model defined above, the server usually generates and delivers to a client an interface for communicating with a program operating on or controlled by the server device. Where the server is a web server, the interface is a web page. The web page, when displayed by the client device, presents a user with controls for selecting options, issuing commands, and entering text. The controls displayed can take many forms. They may include push-buttons, radio buttons, text boxes, scroll bars, or pull-down menus accessible using a keyboard and/or a pointing device such as a mouse connected to a client device. In a non-graphical environment, the controls may include command lines allowing the user to enter textual commands.

INTRODUCTION: In distributed computing environments, a user employs a client to request access to one or more network resources. The user must be authenticated before access to the resources is granted. It is expected that various embodiments of the present invention will provide a decentralized and autonomous system or systems for authenticating a user to allow that user access to the network resource.

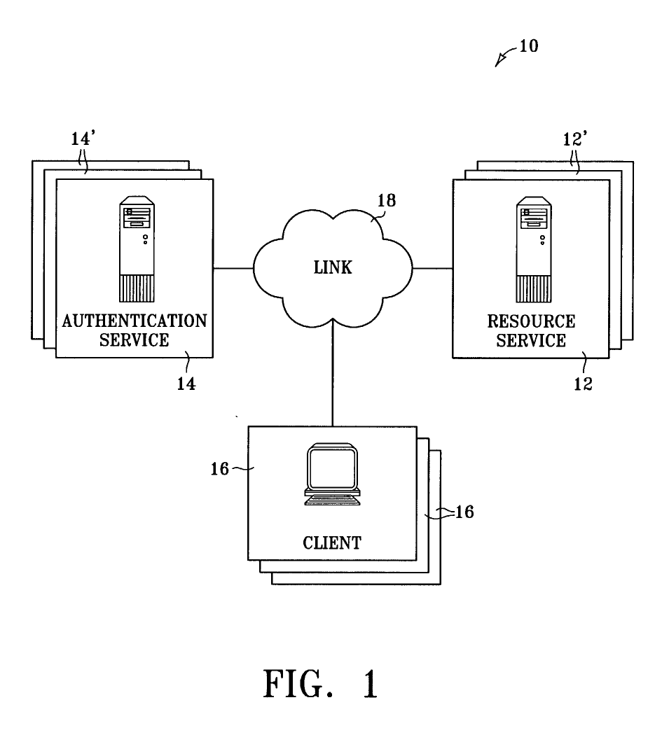

Although the various embodiments of the invention disclosed herein will be described with reference to the computer network 10 shown schematically in FIG. 1, the invention is not limited to use with network 10. The invention may be implemented in or used with any computer system in which it is necessary or desirable to access electronic data. The following description and the drawings illustrate only a few exemplary embodiments of the invention. Other embodiments, forms, and details may be made without departing from the spirit and scope of the invention, which is expressed in the claims that follow this description.

Referring to FIG. 1, computer network 10 represents generally any local or wide area network in which a variety of different electronic devices are linked. Network 10 includes resource service 12, authentication service 14, and client 16 interconnected by link 18. Resource service 12 represents generally any combinations of hardware and/or programming capable of making a resource available to client 16 over network 10. A resource, for example, may be a web page or a web service or any other programming or data capable of being distributed over network 10. Authentication service 14 represents generally any combination of hardware and/or programming capable of authenticating a user. Client 16 represents generally any combination of hardware and/or programming capable of enabling a user to interact with resource service 12 and authentication service 14. Network 10 may include one or more additional resource services 12′, one or more additional authentication services 14′ and one or more additional clients 16′.

Link 18 interconnects network components 12, 14, and 16 and represents generally a cable, wireless, or remote connection via a telecommunication link, an infrared link, a radio frequency link, or any other connector or system that provides electronic communication between devices 12, 14 and 16. Link 18 may represent an intranet, an Internet, or a combination of both. Components 12, 14, and 16 can be connected to network 10 at any point and the appropriate communication path established logically between components 12, 14, and 16.

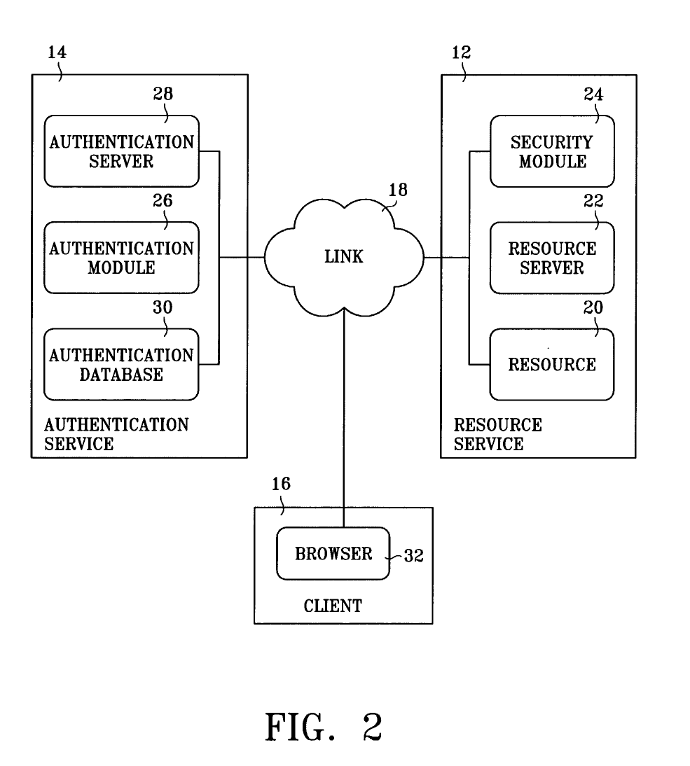

COMPONENTS: The logical components of one embodiment of the invented secure user authentication system will now be described with reference to the block diagram of FIG. 2. Resource service 12 includes resource 20, resource server 22, and security module 24. Resource 20 represents generally any programming or data that can be distributed over network 10. For example, resource 20 may be a web page or java applet. Resource server 22 represents generally any programming capable of distributing resource 20 over network 10. Security module 24 represents generally any programming capable of limiting access to resource 20 to users authenticated by authentication service 14.

Authentication service 14 includes authentication module 26, authentication server 28, and authentication database 30. Authentication module 26 represents generally any programming capable of authenticating a user and communicating the authentication, at least indirectly, to resource service 12. More specifically, authentication module 26 is responsible for authenticating a user who is attempting to access resource 20. Authentication server 28 represents generally any programming capable of making authentication service 26 available over network 10. Authentication database 30 represents generally any logical memory to contain data used by authentication module 26.

In this example, servers, 22 and 28 are web servers. Consequently, client 16 includes browser 32. Browser 32 may be a commercially available web browser such as Microsoft's Internet Explorer. The browser may be an integral component of another program such as a word processor that enables the program to interact with servers 22 and 28.

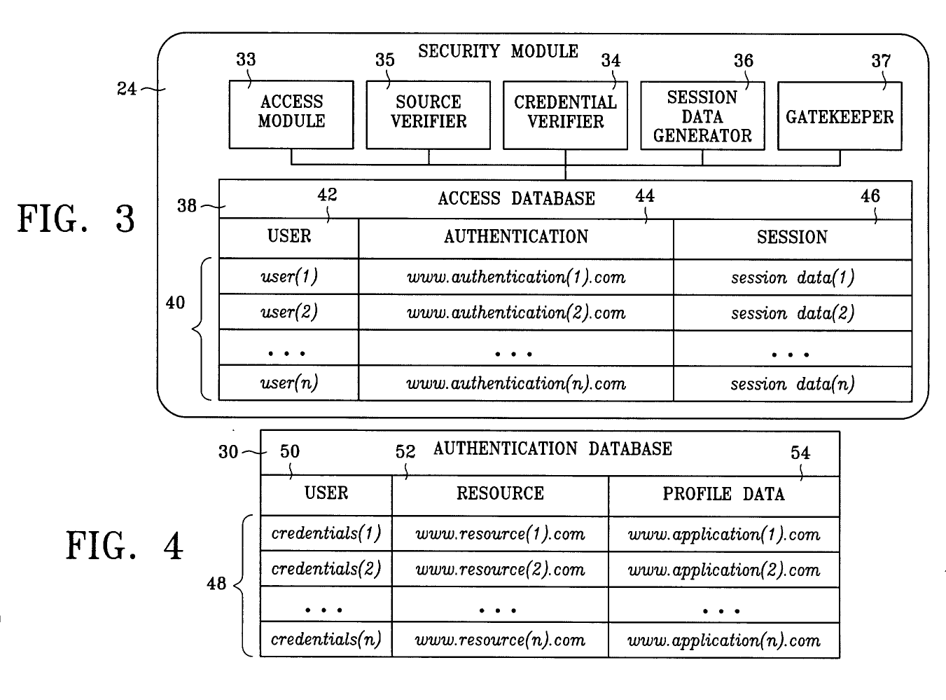

Referring now to FIG. 3, security module 24 includes access module 33, credential verifier 34, source verifier 35, session data generator 36, gatekeeper 37, and access database 38. Access module 33 represents generally any programming capable of identifying a user, identifying an authentication service 14 for the user, and redirecting a client to an identified authentication service 14. Credential verifier 34 represents generally any programming capable of verifying the validity of credentials presented to access resource 20. Source verifier 35 represents generally any programming capable of verifying the authenticity of the source of a communication directed to resource service 12. Session data generator 36, as its name indicates, represents generally any programming capable of generating session data. A session in this case is an instance of a particular user accessing or attempting to access resource 20. As resource 20 is distributed over network 10, it may be accessed by more than one user at one time. Each instance of a user accessing resource 20 is a resource session. Session data is any data uniquely identifying a particular resource session—for example—a randomly generated number or alphanumeric string. Ideally, session data is generated using cryptographic random numbers. Gatekeeper 37 represents generally any programming capable of allowing access to resource 20 only where a user is properly authenticated.

Access database 38 represents any logical memory to contain data used by access module 33, credential verifier 34, and session data generator 36. As illustrated, access database 38 includes a number of entries 40. Each entry 40 contains a user field 42, an authentication field 44, and a session field 46. In each entry 40, user field 42 contains data unique to a particular user. It is expected that this data will include a simple user identifier as well as a copy of credentials needed by the user to access resource 20. The authentication field 44 in a given entry 40 contains data identifying an authentication service 14 or 14′ associated with the user identified by data in the user field 42 of that same entry 40. As illustrated, this data may take the form of an URL (Uniform resource Locator) used to access the particular authentication service 14 or 14′. The session field 46 for a given entry 40 contains session data, if any, for the user identified by data in the user field 42 of that same entry 40.

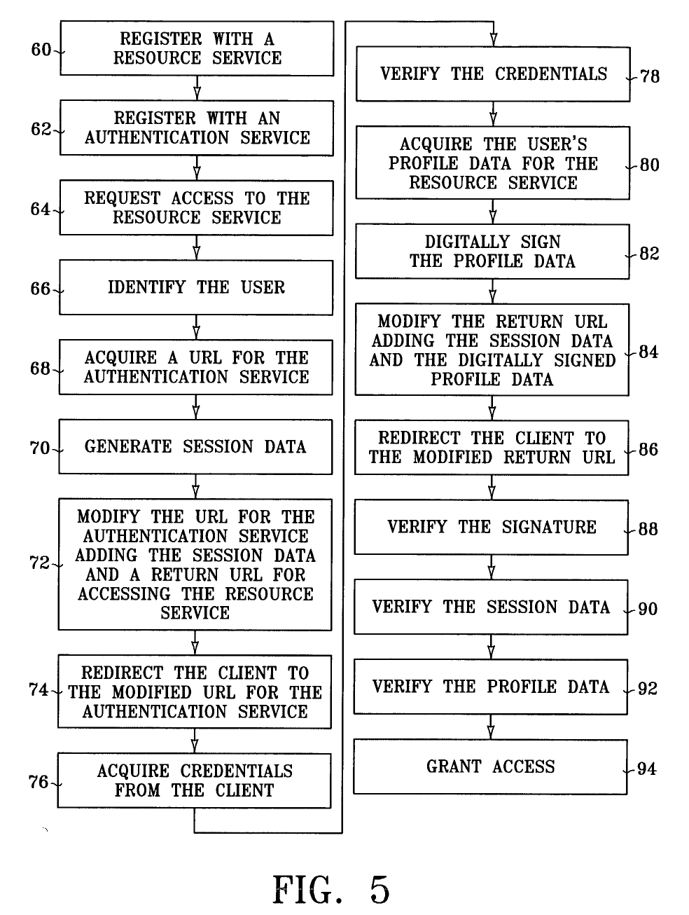

Referring to FIG. 4, authentication database 30 includes a number of entries 48. Each entry 48 contains a user field 50, a resource field 52, and a profile field 54. In each entry 48, user field 50 contains data unique to a particular user. It is expected that this data will include credentials needed to access authentication service 14. The resource field 52 in a given entry 48 contains data identifying a particular resource service 12 or 12′. As illustrated, this data may take the form of an URL used to access the particular resource service 12 or 12′. The profile field 54 for a given entry 48 contains profile data needed to access the resource service 12 or 12′ identified by the resource field 52 for that particular entry 48 and belonging to a user identified by the particular entry's user field 50.

The block diagram of FIGS. 2 and 3 and the table of FIG. 4 show the architecture, functionality, and operation of one implementation of the present invention. If embodied in software, each block may represent a module, segment, or portion of code that comprises one or more executable instructions to implement the specified logical function(s). If embodied in hardware, each block may represent a circuit or a number of interconnected circuits to implement the specified logical function(s).

Also, the present invention can be embodied in any computer-readable medium for use by or in connection with an instruction execution system such as a computer/processor based system or other system that can fetch or obtain the logic from the computer-readable medium and execute the instructions contained therein. A “computer-readable medium” can be any medium that can contain, store, or maintain programs and data for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as a floppy diskette or hard drive, a random access memory (RAM), a read-only memory (ROM), an erasable programmable read-only memory, or a portable compact disc.

OPERATION: The operation of the invented secure user authentication method will now be described with reference to the flow diagram of FIG. 5. FIG. 5 illustrates an example of steps taken to grant a request to access resource 20. In this example, servers 22 and 28 are web servers.

Initially, a user registers with resource service 12 (step 60). This involves providing resource service 12 with data identifying authentication service 14. The user may also provide, or resource service 14 may generate, data uniquely identifying the user. Security module 24 creates a new entry 40 in access database 38 containing the data provided and/or generated. While the data identifying the user is stored in the user field 42 of the new entry 40, that data may also be saved on client 16 in the form of a cookie. A cookie is a message given to a browser by a web server. The browser stores the message in a text file. The message, in many cases, is a simple alphanumeric data string unique to the given browser. The message is then sent back to the server each time the browser sends a request to the web server. In this case the cookie's message would represent the data identifying the user. With the cookie stored on client 16, each time the user accesses resource service 12, using browser 32, resource server 22 can acquire that cookie enabling security module 24 to locate the appropriate entry 40.

The user also registers with authentication service 14 (step 62). This involves providing authentication service 14 with data identifying resource service 12 as well as profile data needed to access resource service 12. With or without input from the user, authentication service 14 generates credentials uniquely identifying the user. Using the provided and generated data, authentication module 26 then creates a new entry 48 in authentication database 30. Again, while the data identifying the user is stored in the user field 50 in the new entry 48, that data may also be stored on client 16 in the form of a cookie. Consequently, each time a user accesses authentication service 14 using browser 32, authentication server 28 can retrieve the cookie enabling authentication module 26 to locate the new entry 48.

Through browser 32, the user requests access to resource service 12 (step 64). Typically, this involves browsing to a network address such as an URL established for resource service 12. Resource server 22 receives the request from browser 32, retrieves a cookie containing data identifying the user from browser 32, and forwards the request and the cookie's message to security module 24. Access module 33 identifies the user (step 66) by utilizing the cookie's message to locate an entry 40 in access database 38 having data in its user field 42 identifying the user. From the authentication field 44 in the located entry 40, access module 33 retrieves data identifying authentication service 14—in this case an URL for authentication service 14 (step 68).

Session data generator 36 generates and stores session data in session field 46 of the located entry 40—replacing any previous data contained in session field 46 (step 70). Access module 33 retrieves the newly generated session data from the located entry 40 and modifies the URL for authentication service 14 by adding the session data and return access data for accessing resource service 12 if the user is successfully authenticated (step 72). The following is an example of such a modified URL: https://www.authentication.com/default?session=12345 ?return=http://www.resource.com. The portion “www.authentication.com/default” is used to access authentication service 14. The portion “?session=12345” represents the added session identifier. The portion “?return=www.resource.com” represents return access data, in this case, an URL for accessing resource service 12. The portion “https” indicates that secure hypertext protocol is being used. Access module 33 then directs resource server 22 to redirect browser 32 to the modified URL for authentication service 14 step (74).

When redirected, browser 32 uses the modified URL to request access to authentication service 12. Authentication server 28 receives the request and acquires credentials from client 16 (step 76). It is expected that these credentials will be in a cookie stored on client 16 after the user registered with authentication service 14 in step 62. Where no cookie exists or a previous cookie has expired, authentication server 28 may redirect browser 32 back to an URL for resource service 12 that will cause browser 32 to display content informing the user that the user's identity has not been authenticated and enable the user to manually provide data, such as a user name and password, authenticating the user's identity. Alternatively, where no cookie is present, authentication server 28 may return content to browser 32 informing the user that the user's identity has not been authenticated and enabling the user to manually provide credentials such as a user name and password, thereby, authenticating the user's identity. Following this alternate approach, authentication server 28 can then set a cookie on client 16.

Authentication server 28 forwards the request, the credentials and the session data and returns access data added in step 72 to authentication module 26. Authentication module 26 verifies the credentials (step 78) locating an entry 48 in authentication database 30 having a user field 50 containing data identifying the user and a resource field 52 containing data identifying the resource service, in this case resource service 12, identified by the return URL. The data identifying the user may well be a replica of the credentials acquired in step 76. From the profile field 54 of the located entry 48, authentication module 26 acquires the user's policy data for resource service 12 (step 80).

Authentication module 26 digitally signs the profile data (step 82). To do so, authentication module 26 adds its digital certificate to the profile data. A digital certificate is an attachment to an electronic message used for security purposes. The most common use of a digital certificate is to verify that a user sending a message is who he or she claims to be, and to provide the receiver with the means to encode a reply. An individual wishing to send an encrypted message applies for a digital certificate from a Certificate Authority (CA). The CA issues an encrypted digital certificate containing the applicant's public key and a variety of other identification information. The CA makes its own public key readily available through print publicity or perhaps on the Internet. The recipient of an encrypted message uses the CA's public key to decode the digital certificate attached to the message, and verify the certificate as being issued by the CA.

Authentication module 26 then modifies the return access data, the data added in step 72, by adding to it the signed profile data and the session data (step 84). Authentication module 26 instructs authentication server 28 to redirect browser 32 to resource service 12 using the modified return data (step 86). When redirected, browser 32, using the modified return data, requests access to resource service 12. Resource server 22 receives and forwards the request along with the signed profile data and the session data added to the return data in step 84 to security module 24. Source verifier 35 verifies that the digital signature used to sign the profile data does in fact identify authentication service 14 (step 88). Source verifier 35 also verifies the session data (step 90). To do so, source verifier 35 locates the entry 40 in access database 38 with a user field 42 containing data identifying the user. Source verifier 35 compares the session data added to the return URL in step 84 with the session data in the session field 46 of the located entry 40. If they match, the session data is verified. Where the signature and session data are verified, security module 24 can be assured that client 32 was redirected in step 86 by authentication service 14 to which browser 32 was redirected in step 74.

Credential verifier 34 then verifies the profile data (step 92). It is expected that the profile data will contain credentials or other data needed for the user to access resource 20. Only when the signature, the session data, and the profile data are each verified, does gatekeeper 37 grant access to resource 20 (step 94). With access granted, resource 20 directs resource server 22 to return content to browser 32 enabling the user to interact with resource 20.

Although the flow chart of FIG. 5 shows a specific order of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details, and embodiments may be made without departing from the spirit and scope of the invention which is defined in the following claims.

What is claimed is:

1. In a computer network, a user authentication method comprising:
receiving a request from a client to access a resource;
acquiring access data for an authentication service and return access data for the resource; and
directing the client to request authentication, the direction including the access data for the authentication service and the return access data for the resource.

2. The method of claim 1, further comprising modifying the access data for the authentication service to include the return access data for the resource, and wherein directing comprises directing the client to the authentication service using the modified access data.

3. The method of claim 1, further comprising generating session data and wherein directing comprises directing the client to request authentication, the direction including the access data for the authentication service, the return access data for the resource, and the session data.

4. The method of claim 1, further comprising receiving a subsequent request from the client to access the resource made using the return access data and granting access to the resource.

5. The method of claim 4, wherein receiving a subsequent request comprises receiving a subsequent request that includes signed profile data, the method further comprising verifying a signature used to sign the profile data to ensure that the client was directed to request access to the resource by the authentication service and verifying the profile data to ensure the user has permission to access the resource, wherein granting access comprises granting access only after the signature and the profile data are each verified.

6. The method of claim 4, further comprising generating session data and wherein modifying includes adding the session data to the access data, wherein receiving the subsequent request comprises receiving a subsequent request that includes the session data, the method further comprising verifying the session data before granting access.

7. In a computer network, a method comprising:
receiving a request from a client to access an authentication service, the request including return access data for a resource;
authenticating a source of the request; and
if authenticated, directing the client to the resource using the return access data.

8. The method of claim 7, wherein authenticating comprises verifying credentials acquired from the client.

9. The method of claim 8, wherein the credentials are a cookie.

10. The method of claim 7, further comprising acquiring profile data for the resource, modifying the return access data for the resource to include the profile data, and wherein directing comprises directing the client to request access to the resource, the direction including the return access data for the resource and the profile data.

11. The method of claim 10, wherein:
receiving the request includes receiving a request from a client to access an authentication service, the request including return access data for a resource and session data; and
modifying comprises modifying the return access data for the resource to include the profile data and the session data.

12. The method of claim 7 further comprising digitally signing the return access data.

13. The method of claim 7, further comprising receiving from the client a request to access a resource made using the return access data and granting access to the resource.

14. The method of claim 11, further comprising:
receiving from the client a request to access a resource made using the modified return access data;
verifying the session data to ensure that the client was directed to request access to the resource by an authentication service to which the client was directed following a previous request by the client to access the resource;
verifying the profile data to ensure the user has permission to access the resource; and
granting access to the resource if the session data and profile data are verified.

15. The method of claim 12 further comprising:
receiving from the client a request to access a resource made using the signed return access data;
verifying a signature used to sign the return access data to ensure that the client was directed to request access to the resource by the authentication service; and
granting access to the resource if the signature is verified.

16. In a computer network, a user authentication method comprising:
in response to receiving a first request from a client to access a resource:
generating session data;
acquiring access data for an authentication service;
modifying the access data for the authentication service to include the session data and return access data for the resource; and
directing the client to the authentication service using the modified access data for the authentication service;
in response to the client being directed to the authentication service using the modified access data for the authentication service:
acquiring profile data for the resource;
digitally signing the acquired profile data;
modifying the access data for the resource to include the signed profile data and the session data received with the request; and
directing the client to the resource using the modified access data for the resource; and
in response to the client being directed to the resource using the modified access data for the resource:
verifying a signature used to sign the profile data and the session data received with the second request to ensure that the second request was caused by the authentication service to which the client was directed following and as a result of the first request to access the resource;
verifying the profile data to ensure the user has permission to access the resource; and
granting access only after the signature, the session data, and the profile data are each verified.

17. Computer readable media having instructions for:
receiving a request from a client to access a resource;
acquiring access data for an authentication service and return access data for the resource; and
directing the client to request authentication, the direction to include the access data for the authentication service and the return access data for the resource.

18. The media of claim 17, having further instructions for modifying the access data for the authentication service to include the return access data for the resource, and wherein the instructions for directing comprise instructions for directing the client to the authentication service using the modified access data.

19. The media of claim 16, having further instructions for generating session data and wherein and wherein the instructions for directing comprise instructions for directing the client to request authentication, the direction including the access data for the authentication service, the return access data for the resource, and the session data.

20. The medium of claim 16, having further instructions for:
receiving a subsequent request from the client to access the resource, the subsequent request made using the return access data; and
granting access to the resource.

21. The medium of claim 20, wherein the instructions for receiving a subsequent request comprise instructions for receiving a subsequent request that includes signed profile data, the media having further instructions for:
verifying a signature used to sign the profile data to ensure that the client was directed to request access to the resource by the authentication service; and
verifying the profile data to ensure the user has permission to access the resource; and
wherein the instructions for granting access comprise instructions for granting access only after the signature and the profile data are each verified.

22. The media of claim 18, having further instructions for generating session data and wherein:
the instructions for modifying include instructions for modifying the access data to include the session data; and
the instructions for receiving the subsequent request comprise instructions for receiving a subsequent request that includes the session data; and
the media further comprising instructions for verifying the session data before granting access.

23. A computer readable media having instructions for:
receiving a request from a client to access an authentication service, the request including return access data for a resource;
authenticating a source of the request; and
if authenticated, directing the client to the resource using the return access data.

24. The media of claim 23, wherein the instructions for authenticating comprise instructions for verifying credentials acquired from the client.

25. The media of claim 23, having further instructions for acquiring profile data for the resource, and wherein the instructions for directing comprise instructions for directing the client to request access to the resource, the direction to include the return access data for the resource and the profile data.

26. The media of claim 25, wherein:
the instructions for receiving the request include instructions for receiving a request from a client to access an authentication service, the request including return access data for a resource and session data; and
the instructions for modifying comprise instructions for modifying the return access data for the resource to include the profile data and the session data.

27. The media of claim 23 having further instructions for digitally signing the return access data.

28. The media of claim 23, having further instructions for:
receiving from the client a request to access a resource made using the return access data; and
granting access to the resource.

29. The media of claim 26, having further instructions for:
receiving from the client a request to access a resource made using the modified return access data;
verifying the session data to ensure that the client was directed to request access to the resource by an authentication service to which the client was directed following a previous request by the client to access the resource;
verifying the profile data to ensure the user has permission to access the resource; and
granting access to the resource if the session data and profile data are verified.

30. The media of claim 27, having further instructions for:
receiving from the client a request to access a resource made using the signed return access data;
verifying a signature used to sign the return access data to ensure that the client was directed to request access to the resource by the authentication service; and
granting access to the resource if the signature is verified.

31. A computer readable media having instructions for:
in response to receiving a first request from a client to access a resource:
generating session data;
acquiring access data for an authentication service;
modifying the access data for the authentication service to include the session data and return access data for the resource; and
directing the client to the authentication service using the modified access data for the authentication service;
in response to the client being directed to the authentication service using the modified access data for the authentication service:
acquiring profile data for the resource;
digitally signing the acquired profile data;
modifying the access data for the resource to include the signed profile data and the session data received with the request; and
directing the client to the resource using the modified access data for the resource; and
in response to the client being directed to the resource using the modified access data for the resource:
verifying a signature used to sign the profile data and the session data received with the second request to ensure that the second request was caused by the authentication service to which the client was directed following and as a result of the first request to access the resource;
verifying the profile data to ensure the user has permission to access the resource; and
granting access only after the signature, the session data, and the profile data are each verified.

32. In a computer network, a user authentication system comprising:
a resource server operable to receive a request from a client to access a resource; and
an access module operable to acquire access data for an authentication service, to modify the access data for the authentication service to include
return access data for the resource, and to direct the client to the authentication service using the modified access data for the authentication service.

33. The system of claim 32, further comprising a session data generator operable to generate session data for the resource in response to a received request to access the resource, and wherein the access module is further operable to modify the access data for the authentication service to include return access data for the resource and the generated session data.

34. The system of claim 32, wherein the resource server is further operable to receive a subsequent request from the client to access the resource made using the return access data, the system further comprising a gatekeeper operable to grant the subsequent request.

35. The system of claim 34, wherein the resource server is further operable to receive a subsequent request that includes signed profile data, the system further comprising:
source verifier operable to verify a signature used to sign the profile data to ensure that the client was directed to request access to the resource by the authentication service; and
a credential verifier operable to ensure the user has permission to access the resource; and
wherein the gatekeeper is operable to grant the subsequent request only after the signature and the profile data are each verified.

36. The system of claim 34, further comprising a session data generator operable to generate session data and wherein:
the access module is further operable to modify the access data for the authentication service to include return access data for the resource and the generated session data; and
the resource server is further operable to receive a subsequent request from the client to access the resource made using the return access data modified to include the session data; and
the system further comprising a source verifier operable to verify session data received with a subsequent request, and wherein the gatekeeper is further operable to grant the subsequent request if the session data is verified.

37. In a computer network, a system comprising:
an authentication server operable to receive a request from a client to access an authentication service, the request including return access data for a resource; and
an authentication module operable to authenticate a source of the request, and, if authenticated, to direct the client to the resource using the return access data.

38. The system of claim 37, wherein the authentication module is further operable to acquire profile data for the resource, modify the return access data for the resource to include the profile data, and direct the client to the resource using the modified return access data.

39. The system of claim 37, wherein:
the authentication server is further operable to receive a request from a client to access an authentication service, the request including return access data for a resource and session data; and
the authentication module is further operable to modify the return access data for the resource to include the profile data and the session data.

40. The system of claim 37 wherein the authentication module is further operable to digitally sign the return access data.

41. The system of claim 37, further comprising a resource server operable to receive a request from the client a request to access a resource made using the return access data and a gatekeeper operable to grant access to the resource.

42. The system of claim 39, further comprising:
a resource server operable to receive a request from a client to access a resource made using the modified return access data;
a source module operable to verifying the session data to ensure that the client was directed to request access to the resource by an authentication service to which the client was directed following a previous request by the client to access the resource;
a credential verifier operable to verifying the profile data; and
a gatekeeper operable to grant access to the resource if the session data and profile data are verified.

43. The method of claim 40 further comprising:
a resource server operable to receive from the client a request to access a resource made using the signed return access data;
a source verifier operable to verify a signature used to sign the return access data to ensure that the client was directed to request access to the resource by the authentication service; and
a gatekeeper operable to grant access to the resource if the signature is verified.

44. In a computer network, a user authentication system comprising:
a resource server operable to receive a first and second requests from a client to access a resource, second requests including signed profile data and session data;
a session data generator operable to generate session data for the resource in response to a received request to access the resource;
an access module operable to acquire access data for an authentication service, to modify the access data for the authentication service to include the generated session data and return access data for the resource, and to direct the client to the authentication service using the modified access data for the authentication service;
a source verifier operable to verify a signature used to sign profile data and session data both included with a second request in order to ensure that the second request resulted from the client being directed to access the resource by an authentication service to which the client was directed following a first request;
a credential verifier operable to verify the profile data to ensure the user has permission to access the resource; and
a gatekeeper operable to grant access to the resource only after the signature, the session data, and the profile data are each verified.

45. In a computer network, a user authentication system comprising:
a resource server operable to receive a first and second requests from a client to access a resource, second requests including signed profile data and session data;
a session data generator operable to generate session data for the resource in response to a received request to access the resource;
an access module operable to acquire access data for an authentication service, to modify the access data for the authentication service to include the generated session data and return access data for the resource, and to direct the client to the authentication service using the modified access data for the authentication service;
an authentication server operable to receive an access request from a client, the request including session data and access data for a resource; and
an authentication module operable to acquire profile data for the resource, to digitally sign the acquired profile data, to modify the access data for the resource to include the signed profile data and the session data received with the request, and to direct the client to the resource using the modified access data;
a source verifier operable to verify a signature used to sign profile data and session data both included with a second request in order to ensure that the
second request resulted from the client being directed to access the resource by an authentication service to which the client was directed following a first request;
a credential verifier operable to verify the profile data to ensure the user has permission to access the resource; and
a gatekeeper operable to grant access to the resource only after the signature, the session data, and the profile data are each verified.

46. In a computer network, a user authentication system comprising:
a means for receiving first and second requests from a client to access a resource, second requests including signed profile data and session data;
a means for generating session data for the resource in response to a received request to access the resource;
a means for acquiring access data for an authentication service;
a means for modifying the access data for the authentication service to include the generated session data and return access data for the resource;
a means for directing the client to the authentication service using the modified access data for the authentication service;
a means for receiving an authentication access request from a client, the authentication access request including session data and access data for a resource;
a means for acquiring profile data for the resource;
a means for digitally signing the acquired profile data;
a means for modifying the access data for the resource to include the signed profile data and the session data received with the authentication access request;
a means for directing the client to the resource using the modified access data for the resource;
a means for verifying a signature used to sign profile data and session data both included with a second request in order to ensure that the second request resulted from the client being directed to access the resource by an authentication service to which the client was directed following a first request;
a means for verifying profile data to ensure the user has permission to access the resource; and
a means for granting access to the resource only after the signature, the session data, and the profile data are each verified.
